(19) United States
(12) Patent Application Publication
(10) Pub. No.: US 2006/0239569 A1
(43) Pub. Date: Oct. 26, 2006

(54) System to rapidly compress and decompress binary image and method thereof

(76) Inventor: Ho-Keun Lee, Suwon-si (KR)

Correspondence Address: STANZIONE & KIM, LLP, 919 18TH STREET, N.W., SUITE 440, WASHINGTON, DC, 20006, US

(21) Appl. No.: 11/294,451

(22) Filed: Dec. 6, 2005

(30) Foreign Application Priority Data
Apr. 21, 2005 (KR) 2005-33043

(51) Int. Cl. G06K 9/36; H04N 11/02; H04N 1/41

(52) U.S. Cl. 382/236; 382/232; 348/384.1; 358/426.01

(57) ABSTRACT

A system and method of rapidly compressing and decompressing a binary image. The method of rapidly compressing the binary image includes initializing a 0 count value obtained by counting 0 blocks and also initializing a 0 output control value that is information on the number of continuous 0 blocks; estimating pixel values of a current block using binary values of a previous line continuously input immediately prior to the current line to be coded and also using screen mask values of the previous line; estimating binary values of the current block using the estimated pixel values and the screen mask values corresponding to the current block; comparing the estimated binary values with corresponding ones of the actual binary values of the current block to calculate errors and to thus generate an error pattern; and coding the current line block by block based on the 0 count value, the 0 output control value, and the generated error pattern. A reverse order of operation of the method may be used during the rapid decompression of a coded input image. Therefore, the image data may be rapidly compressed and decompressed on a block-by-block basis using the pixel values of the previous line.

### CROSS-REFERENCE TO RELATED APPLICATIONS

This application claims benefit of Korean Patent Application No. 2005-33043, filed Apr. 21, 2005, in the Korean Intellectual Property Office, the disclosure of which is incorporated herein by reference in its entirety.

### BACKGROUND OF THE INVENTION

1. Field of the Invention

The present general inventive concept relates to a system to rapid compress and decompress a binary image and a method thereof, and more particularly, to a system and method of rapidly compressing and decompressing a binary image in which image data of a current line are compressed and decompressed in parallel using pixel values of a previous line that is input prior to the current line.

2. Description of the Related Art

FIG. 1 illustrates a conventional method of compressing a binary image. Here, “P” denotes a current pixel to be compressed and “Xs” denote previous pixels prior to the current pixel to be compressed. The pixels of a line of an image that includes the pixel to be compressed (here, pixel “P”) are referred to as “previous” pixels.

Referring to FIG. 1, according to the conventional method of compressing and transmitting the binary image, the pixel adjacent to the current pixel to be compressed is used. Therefore, the current pixel can be compressed only when the pixel prior to the current pixel is processed and the current pixel must be first processed in order to process the pixels after the current pixel. Therefore, the compression of image data is processed pixel-by-pixel, thereby reducing a compression speed. Because the decompression of the image data must also be processed pixel by pixel, a decompression speed is also reduced.

Therefore, in order to rapidly compress and decompress image data, a system and method of compressing and decompressing a binary image in which image data are not processed pixel-by-pixel, but are processed in parallel is desirable.

### SUMMARY OF THE INVENTION

The present general inventive concept provides a system and method of rapidly compressing and decompressing a binary image in which image data are compressed and decompressed using pixel values and screen mask values of a previous line that is continuously input prior to a current line to be compressed and decompressed in an input image. This allows for processing of the image data in parallel so that it is possible to rapidly compress and decompress the image data.

Additional aspects and utilities of the present general inventive concept will be set forth in part in the description which follows and, in part, will be obvious from the description, or may be learned by practice of the general inventive concept.

The foregoing and/or other aspects of the present general inventive concept may be achieved by providing a method of rapidly compressing a binary image, the method comprising initializing a 0 count value which is obtained and changed by counting 0 blocks in which actual binary values of a current block are equal to estimated binary values in an input image containing a plurality of lines each formed of one or more blocks each containing a plurality of predetermined number of pixels, initializing a 0 output control value that is information on the number of continuous 0 blocks, estimating the pixel values of the current block using the pixel values of the previous line continuously input prior to the current line to be coded and the screen mask values corresponding to the previous line, estimating the binary values of the current block using the estimated pixel values and the screen mask values corresponding to the current block, comparing the estimated binary values with the actual binary values of the current block to calculate errors and to generate an error pattern, and coding the current line by block based on the 0 count value, the 0 output control value, and the generated error pattern.

The method further comprises determining whether the input of the input image is completed and that the 0 count value and the 0 output control value are initialized when the input of the input image is not completed and the coding of the current line is terminated when the input of the input image is completed.

The estimating of the pixel values of the current block may comprises calculating an average value of values obtained by multiplying the binary values of the previous line by the screen mask values corresponding to the previous line to estimate the pixel values of the current block.

The estimating of the binary values of the current block may comprises comparing the estimated pixel values of the current block with the screen mask values corresponding to the current block to estimate the binary values of the current block.

The initializing of the 0 count value and the 0 output control value comprises setting the 0 count value as 0 and the 0 output control value as 1.

The error pattern may comprise a pattern in which the errors do not exist, a pattern in which one error exists and which is the same as the error pattern of the previous block continuously input prior to the current block, a pattern in which one error exists and which is different from the error pattern of the previous block, and a pattern in which two or more errors exist.

The coding of the current line may comprise coding the current line block by block so as to include at least one of data on the error pattern in accordance with the error pattern, the 0 count value, the number of bits before and after the bit in which one error exists, and data on errors in the block.

The coding of the current line may comprise coding the current line so as to include data on the errors when one error exists and the error pattern is the same as the error pattern of the previous block continuously input prior to the current block and when no errors exist.

The coding of the current line may comprise coding the current line so as to include first information on the number of bits before and after the bit having an error and second information on the 0 count value that is the number of blocks in which no errors exist among the previous blocks when one error exists and the error pattern is different from the error pattern of the previous block continuously input prior to the current block.

The coding of the current line may comprise coding the current line so as to include information on data on the errors and information on the 0 count value that is the number of blocks in which no errors exist among the previous blocks continuously input prior to the current block when two or more errors exist in accordance with the error pattern.

The coding of the current line may comprise increasing the 0 count value when no errors exist in accordance with the error pattern, and initializing the 0 count value and increasing the 0 output control value when the increased 0 count value is equal to the 0 output control value.

The coding of the current line may comprise reducing the 0 output control value and initializing the 0 count value when one error exists in accordance with the error pattern.

The foregoing and/or other aspects of the present general inventive concept may also be achieved by providing a method of rapidly decompressing a binary image, the method comprising decompressing a coded block based on an error pattern between actual binary values generated block by block in an image which contains a plurality of coded lines each formed of one or more coded blocks each being a processing unit and having a predetermined pixels, and estimated binary values of the coded block, estimating the pixel values of the block using the binary values of the previous line continuously input prior to the current line to be decompressed and the screen mask values corresponding to the previous line, estimating the binary values of the block using the estimated pixel values and the screen mask values corresponding to the block, and decompressing the image data of the coded current line based on the estimated binary values and the decompressed errors.

The method may further comprise determining whether the input of the input image is completed, and initializing the 0 count value and the 0 output control value when the input of the input image is not completed, and terminating the coding of the current line when the input of the input image is completed.

The estimating of the pixel values of the block may comprise calculating an average value of values obtained by multiplying the binary values of the previous line by the screen mask values corresponding to the previous line to estimate the pixel values of the block.

The estimating of the binary values of the block may comprise comparing the estimated pixel values of the block with the screen mask values corresponding to the block to estimate the binary values of the block.

The error pattern may comprise a pattern in which the errors do not exist, a pattern in which one error exists and which is the same as the error pattern of the previous block continuously input prior to the block, a pattern in which one error exists and which is different from the error pattern of the previous block, and a pattern in which two or more errors exist.

The decompressing of the image data of the current line may comprise decompressing the image data block by block using at least one among data on the error pattern in accordance with the decompressed error pattern, the 0 count value, the number of bits before and after the bit in which one error exists in the block, and data on errors in the block.

The decompressing of the image data of the current line may comprise decompressing the image data using information on the number of bits before and after the bit having an error and information on the 0 count value that is the number of blocks in which no errors exist among the previous blocks when one error exists and the error pattern is different from the error pattern of the previous block continuously input prior to the block to be coded.

The decompressing of the image data of the current line may comprise decompressing the image data using information on data on the errors and information on the 0 count value that is the number of blocks in which no errors exist among the previous blocks continuously input prior to the current block when two or more errors exist between the actual binary values of the block and the estimated binary values in accordance with the error pattern.

The decompressing of the image data of the current line may comprise initializing the 0 count value and increasing the 0 output control value when no errors exist between the actual binary values of the block and the estimated binary values in accordance with the error pattern.

The decompressing of the image data of the current line may comprise reducing the 0 output control value and initializing the 0 count value when one error exists between the actual binary values of the block and the estimated binary values in accordance with the error pattern.

The foregoing and/or other aspects of the present general inventive concept may also be achieved by providing an apparatus to rapidly compress a binary image, the apparatus comprising a host counter to update a 0 count value that is obtained by counting the number of 0 blocks in which the actual binary values of the current block in an input image containing a plurality of lines each formed of one or more blocks each containing a plurality of pixels to be coded are equal to the estimated binary values of the input image, and a 0 output control value that is information on the number of continuous 0 blocks, an estimator to estimate the pixel values of the current block using the binary values of the previous line continuously input prior to the current line to be coded and to estimate the binary values of the current block using the estimated pixel values, an error image generator to compare the estimated binary values with the actual binary values of the current block to calculate errors to generate an error pattern, a coding unit to code the current line based on the 0 count value, the 0 output control value, and the generated error patterns, and a controller to initialize the 0 output control value and the 0 count value in accordance with the generated error patterns and to determine whether the coding of the input image is terminated.

The apparatus may further comprise a host storage unit to store the screen mask values of the input image, the actual binary values of the input image, and the kinds of error patterns and the contents of data in accordance with the kinds of error patterns.

The estimator generate an average value of values obtained by multiplying the binary values of the previous line by the screen mask values corresponding to the previous line to estimate the pixel values of the current block, and compares the estimated pixel values of the current block with the size of the screen mask values corresponding to the current block to estimate the binary values of the current block.

The host counter increases the 0 count value when no errors exist in accordance with the error pattern, and initializes the 0 count value and increases the 0 output control value when the increased 0 count value is equal to the 0 output control value.

The host counter reduces the 0 output control value and initializes the 0 count value when one error exists in accordance with the error pattern.

The coding unit codes the current line so that information on the number of bits before and after the bit having an error and information on the 0 count value that is the number of blocks in which no errors exist among the previous blocks are included when one error exists and the error pattern is different from the error pattern of the previous block continuously input prior to the current block.

The foregoing and/or other aspects of the present general inventive concept may also be achieved by providing an apparatus to rapidly decompress a binary image, the apparatus comprising an error image decompressing unit to decompress a coded block based on an error pattern between actual binary values generated block by block that is a unit of processing an input image, which contains a plurality of coded lines each formed of one or more coded blocks each being a processing unit and having a predetermined pixels, and the estimated binary values of the input image, a host counter to update a 0 count value obtained or changed by counting the number of 0 blocks in which the actual binary values are equal to the estimated binary values, and a 0 output control value that is information on the number of continuous 0 blocks, a calculating unit to calculate the pixel values of the block using the binary values of the previous line continuously input prior to the current line and to calculate the binary values of the block using the estimated pixel values, a decoding unit to decompress the image data of a coded input image based on the estimated binary values and the decompressed error values, and a controller to initialize the 0 output control value and the 0 count value in accordance with the decompressed error pattern and to determine whether the decompression of the input image is terminated.

The apparatus may further comprise a storage unit to store the screen mask values of the input image, the actual binary values of the image, and the kinds of error and the contents of data in accordance with the kinds of error.

The calculating unit may calculate an average value of values obtained by multiplying the binary values of the previous line by the screen mask values corresponding to the previous line to estimate the pixel values of the block, and may compare the calculated pixel values of the block with the size of the screen mask values corresponding to the block to calculate the binary values of the block.

The host counter may initialize the 0 count value and increase the 0 output control value when no errors exist between the actual binary values of the block and the estimated binary values, and may initialize the 0 count value and reduce the 0 output control value when at least one error exists.

The decompressing unit may decompress block by block using at least one among data on the error pattern in accordance with the decompressed error pattern, the 0 count value, the number of bits before and after the bit in which one error exists, and data on errors in the block.

The decompressing unit may decompress using information on the number of bits before and after the bit having an error and information on the 0 count value that is the number of blocks in which no errors exist among the previous blocks when one error exists and the error pattern is different from the error pattern of the previous block continuously input prior to the coded block.

The decompressing unit may decompress using information on data on the errors and information on the 0 count value that is the number of blocks in which no errors exist among the previous blocks continuously input prior to the block when two or more errors exist between the actual binary values of the block and the estimated binary values in accordance with the error pattern.

The foregoing and/or other aspects of the present general inventive concept may also be achieved by providing a system to rapidly compress and decompress a binary image, the system comprising a host counter to update a 0 count value that is obtained by counting the number of 0 blocks in which actual binary values of a current block to be coded and decompressed in an input image which contains a plurality of lines each formed of one or more blocks each containing a plurality of pixels, are equal to the estimated binary values, and to update a 0 output control value that is information on the number of continuous 0 blocks, an estimator to estimate the pixel values of the current block using the binary values of the previous line continuously input prior to the current line to be coded and decompressed and to estimate the binary values of the current block using the estimated pixel values, an error image generator to compare the estimated binary values with the actual binary values of the current block to calculate errors and to generate an error pattern, a coding unit to code the current line based on the 0 count value, the 0 output control value, and the generated error pattern, an error image decompressing unit to decompress the error pattern of the coded current block, a decoding unit to decompress the image data of the coded input image based on the estimated binary values and the decompressed error values, and a controller to initialize the 0 output control value and the 0 count value in accordance with the generated error patterns and to determine whether the coding and decompression of the input image are terminated.

The foregoing and/or other aspects of the present general inventive concept may also be achieved by providing a method of rapidly compressing and decompressing a binary image, the method comprising initializing a 0 count value which is changed by counting 0 blocks in which the actual binary values of the current block to be coded in an input image, which contains a plurality of lines each formed of one or more blocks each containing a plurality of pixels, are equal to estimated binary values, initializing a 0 output control value that is information on the number of continuous 0 blocks, estimating the pixel values of the current block using the pixel values of the previous line continuously input prior to the current line to be coded and the screen mask values corresponding to the previous line, estimating the binary values of the current block using the estimated pixel values and the screen mask values corresponding to the current block, comparing the estimated binary values with the actual binary values of the current block to calculate errors and to generate an error pattern, coding the current line by block based on the 0 count value, the 0 output control value, and the generated error patterns, decompressing the coded block based on the error pattern, and decompressing the image data of the coded current line based on the estimated binary values and the decompressed error pattern.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates a conventional method of compressing a binary image;

FIG. 2 is a block diagram illustrating a system to rapidly compress and decompress a binary image according to an embodiment of the present general inventive concept;

FIG. 3 is a flowchart illustrating a method of rapidly compressing a binary image using the system of FIG. 2 according to an embodiment of the present general inventive concept;

FIGS. 4A to 4E illustrate pixels and patterns generated according to the method of FIG. 3;

FIGS. 5A to 5F illustrate values of the method of FIG. 3; and

FIG. 6 is a flowchart illustrating a method of rapidly decompressing a binary image according to an embodiment of the present general inventive concept.

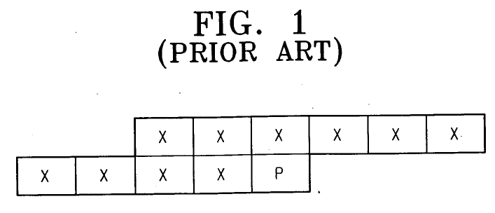

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

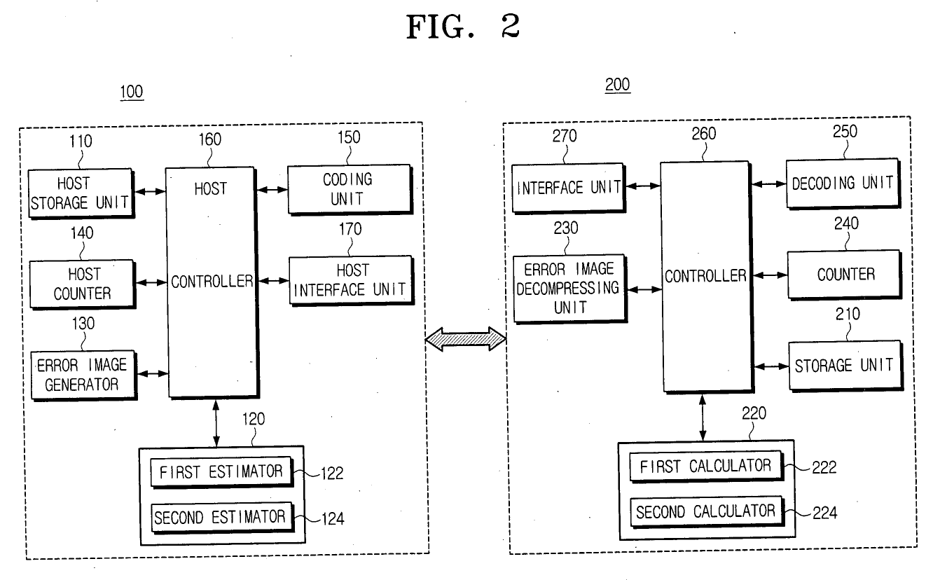

FIG. 2 is a block diagram illustrating a system to rapidly compress and decompress a binary image according to an embodiment of the present general inventive concept.

Referring to FIG. 2, the system includes a host apparatus 100, such as an encoder, to rapidly compress the binary image and an image forming apparatus 200, such as a decoder, to rapidly decompress the binary image compressed by the host apparatus 100.

The host apparatus 100 includes a host storage unit 110, an estimating unit 120, an error image generator 130, a host counter 140, a coding unit 150, a host controller 160, and a host interface unit 170.

The host storage unit 110 stores screen mask values of an input image, e actual binary values of the input image, and a table that represents (1) various kinds of error in accordance with error values between the actual binary values of the current block to be coded and the estimated binary values of the current block of the input image, and (2) the contents of data in accordance with the kind of error. In the discussion hereinbelow, the term “block” is used to refer to a plurality of contiguous pixels in a “line” of an image. The size of a “block” may vary depending on such design considerations as, for example, the line size, the number of pixels to be processed in parallel, etc. In the present embodiment, the block size may be equal to the line size. If there are eight (8) pixels in the block, the block size may equal to eight (8) bits each representing each pixel.

The estimating unit 120 includes a first estimator 122 and a second estimator 124 and estimates pixel values and binary values of the current block to be coded from among blocks that are to be processed during the coding of the input image. The first estimator 122 estimates the pixel values of a current line in the input image using (1) the binary values of a previous line that is continuously input prior to the current line, and (2) the screen mask values corresponding to the previous line in the input image. The first estimator 122 calculates an average value of values obtained by multiplying the binary values of the previous line by the corresponding screen mask values of the previous line to estimate the pixel values of the current block.

The second estimator 124 estimates the binary values of the current block using the estimated pixel values of the current block (as estimated by the first estimator 122) and the screen mask values corresponding to the current block. The second estimator 124 compares the estimated pixel values of the current block with the screen mask values corresponding to the current block to determine the binary values of the current block. The binary value is estimated to be “1” when it is determined that the estimated pixel values are larger than corresponding ones of the screen mask values, and to be “0” when it is determined that the estimated pixel values are smaller than corresponding ones of the screen mask values.

The error image generator 130 generates an error image based on the binary values of the current block estimated by the second estimator 124 and the actual binary values of the current block stored in the host storage unit 110. The error image generator 130 compares the estimated binary values of the current block with the corresponding actual binary values to determine the error values. The error value is a binary “1” when it is determined that the estimated binary values are different from the corresponding actual binary values, and is a binary “0” when it is determined that the estimated binary values are equal to the corresponding actual binary values. Therefore, error patterns that are errors between the actual binary values and the estimated binary values are generated block-by-block or line-by-line. In an alternative embodiment, the error image generator 130 may be set to determine the error values as binary “1” when the estimated binary values are equal to the corresponding actual binary values, and as binary “0” when the estimated binary values are different from the corresponding actual binary values.

The host counter 140 updates a “zero (0) count value that is obtained by counting “zero (0) blocks” 0 blocks, i.e., those blocks in the input image whose error values are zero (0) because, in case of a zero block, no error exists between the estimated binary values of the current block and its actual binary values. The host counter 140 also updates a “zero (0) output control value that conveys information on the number of continuous 0 blocks. The 0 output control value controls the 0 count value so that a binary “0” corresponding to that kind of error which indicates that error values are “0” is output during the coding of the current block. That is, a binary 0 for the kind of error indicating the 0 blocks is output only when the 0 count value is equal to the 0 output control value. It is noted here that for the sake of simplicity and ease of discussion, the term “zero” is omitted from various descriptive terms such as, for example, the “zero count value”, or the “zero blocks”, etc. Instead, the word “zero” in all such and related terms is replaced by the numeral “0” as can be evident from the context of the discussion.

When the 0 blocks are continuously detected, the 0 output control value is increased so that a binary “0” is output when a plurality of continuous 0 blocks are detected. On the other hand, when the 0 blocks are not detected, the 0 output control value is reduced so that a binary “0” for the kind of error indicating 0 blocks is output during the coding of the current block even when a small number of 0 blocks are continuously detected.

The host counter 140 increases the 0 count value when no errors exist between the estimated binary values of the current block and the actual binary values. Then, the host counter 140 initializes the 0 count value to be set as binary “0” and increases the 0 output control value when the 0 count value is equal to the 0 output control value. On the other hand, when one or more errors exist between the estimated binary values of the current block and the corresponding actual binary values, the 0 count value is initialized to be set as binary “0” and the 0 output control value is reduced by one.

The coding unit 150 codes the input image using the error values that are generated block-by-block by the error image generator 130 and using the values in the table stored in the host storage unit 110. A kind of error that corresponds to the error values generated by the current line to be coded is selected from the table and is output to code the current line along with the contents of data (as stored in the host storage unit 110) in accordance with the selected kind of error.

For example, when all of the error values (for the blocks of the input image) generated by the error image generator 130 are 0, a binary “0” corresponding to the kind of error that indicates that all of the error values are 0 is output.

Here, when the current line to be coded is the first line of the input image, the current line is coded assuming that all of the binary values of the previous line are 0. That is, assuming that the previous line is white, the first estimator 122 estimates that the pixel values of the current block (in the current line) are 0 and the second estimator 124 estimates that the binary values of the current block are 0. The coding unit 150 compares the actual binary values with the estimated binary values, and uses the estimated error values and the table stored in the host storage unit 110 to code the first line.

The host interface unit 170 interfaces with the image forming apparatus 200. Therefore, the blocks of the current line coded by the coding unit 150 using the previous line are transmitted to the image forming apparatus 200 through the host interface unit 170.

The host controller 160 controls the operations of various units in the host apparatus 100. The host controller 160 also initializes the 0 count value and the 0 output control value when an input image is initially input. Thus, in the present embodiment, the initial 0 count value of the host counter 140 is set to be 0 and the initial 0 output control value is set to be 1 by the host controller 160.

The host controller 160 controls the host counter 140 so that the host counter 140 increases the 0 count value by one when the error values (of one block) generated by the error image generator 130 are 0 and the host counter 140 increases the 0 output control value by one when the increased 0 count value is equal to the 0 output control value. Thereafter, the host counter 140 initializes the 0 count value.

Also, the host controller 160 determines whether the input of the image data is completed. When it is determined that the input of the image data is completed, the coding of the input image is terminated. When it is determined that the input of the image data is not completed, the host controller 160 controls various units in the host apparatus 100 to perform the coding of the input image block by block.

On the other hand, the image forming apparatus 200 rapidly decompresses a binary image and includes a storage unit 210, a calculating unit 220, an error image decompressing unit 230, a counter 240, a decoding unit 250, a controller 260, and an interface unit 270.

The storage unit 210 stores the screen mask values of image data which have been compressed and a table that represents, for example, two types of values: (1) various kinds of error in accordance with the error values between the actual binary values of the current block to be coded and the corresponding estimated binary values of the current block, and (2) the contents of data in accordance with the kind of error. The screen mask values and table stored in the storage unit 210 can be the same as the screen mask values and table stored in the host storage unit 110 (which are used during the coding of an image).

The error image decompressing unit 230 decompresses the error values of the current block that is adaptively coded in accordance with the error patterns generated by the error image generator 130. The decompression of the error values is performed using information transmitted by the host apparatus 100 on the kinds of error and the contents of data (stored in the storage unit 210) associated with the kinds of error. The error image decompressing unit 230 decompresses the error values of the current block based on information on the kind of the error values of the current block (which is coded and transmitted by the host apparatus 100) and the values in the table stored in the storage unit 210.

The operation of the calculating unit 220 is similar to the operation of the estimating unit 120 of the host apparatus 100. The calculating unit 220 includes a first calculator 222 and a second calculator 224 and estimates the pixel values and the binary values of the current block . The first calculator 222 estimates the pixel values of the current block to be decompressed using (1) the binary values of the previous line that is continuously input prior to the current line, and (2) the screen mask values corresponding to the previous line. The first calculator 222 calculates an average value of values obtained by multiplying the binary values of the previous line by the corresponding screen mask values the previous line to estimate the pixel values of the current block.

The second calculator 224 estimates the binary values of the current block using the estimated pixel values of the current block (as estimated by the first calculator 222) and the screen mask values corresponding to the current block. The second calculator 224 compares the estimated pixel values of the current block with the screen mask values corresponding to the current block to determine the binary values of the current block. The binary value is estimated to be “1” when the estimated pixel values are larger than the screen mask values and to be “0” when the estimated pixel values are smaller than the screen mask values.

The counter 240 updates the 0 count value that is obtained by counting the 0 blocks whose error values are 0 because no errors exist between the estimated binary values of the current block and the corresponding actual binary values. The counter 240 also updates the 0 output control value that conveys information on the number of continuous 0 blocks.

The counter 240 increases the 0 count value upon transmission of data related to that kind of error in which no errors exist between the estimated binary values of the current block and the actual binary values. Then, the counter 240 initializes the 0 count value to be set as binary 0 and increases the 0 output control value when the 0 count value is equal to the 0 output control value. On the other hand, when data on the kind of error in which errors exist between the estimated binary values of the current block and the actual binary values are transmitted, the 0 count value is initialized to be set as binary 0 and the 0 output control value is reduced by one.

The decoding unit 250 decompresses the input image using the error values generated block-by-block by the error image decompressing unit 230 and the binary values estimated by the second calculator 224. When the error values generated by a block of the current line to be decompressed are “0,” the estimated binary values are output, as they are, as the image data of the current block. When the error values are “1,” the inverted values of the estimated binary values are output as the image data of the current block.

The interface unit 270 interfaces with the host apparatus 100. The blocks of the current line coded using the previous line are transmitted by the host apparatus 100 to the image forming apparatus 200 through the interface unit 270.

The controller 260 controls the operations of various units in the image forming apparatus 200. The controller 260 also initializes the 0 count value and the 0 output control value when an input image is initially input. Thus, in the present embodiment, the initial 0 count value of the counter 240 is set to be binary “0” and the initial 0 output control value is set to be binary “1” by the controller 260.

The controller 260 controls the counter 240 so that the counter 240 initializes the 0 count value and increases the 0 output control value when the error values (of one block) generated by the error image decompressing unit 240 are 0.

Also, the controller 260 determines whether the input of the compressed image data is completed. When it is determined that the input of the image data from the host apparatus 100 is completed, the decompressing of the input image is terminated. When it is determined that the input of the image data is not completed, the controller 260 controls various units in the apparatus 200 to perform the decompression of the input image block by block.

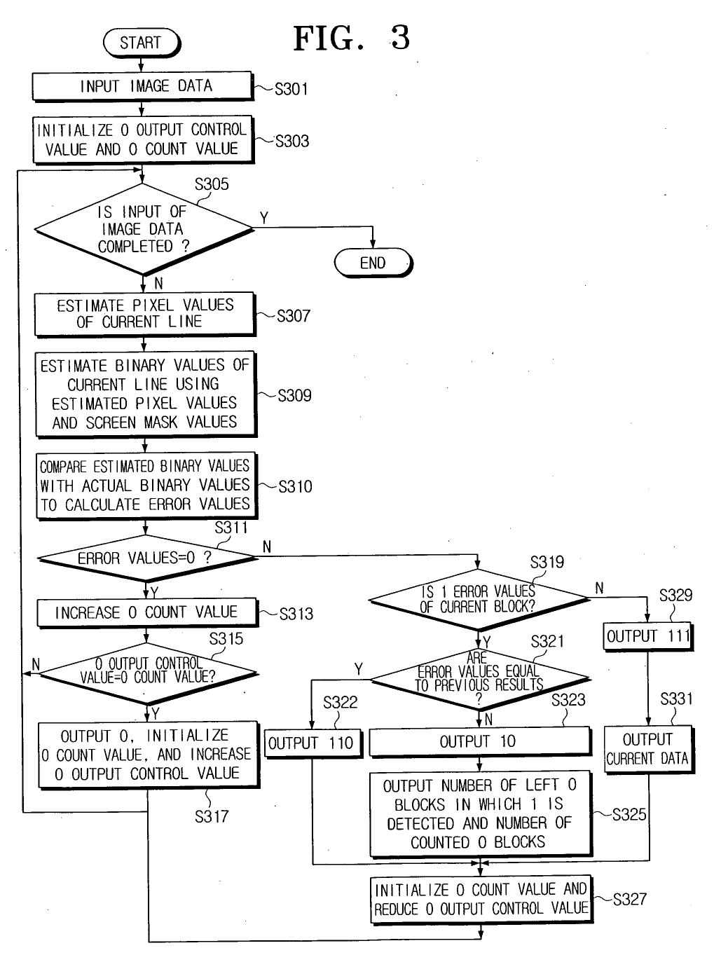

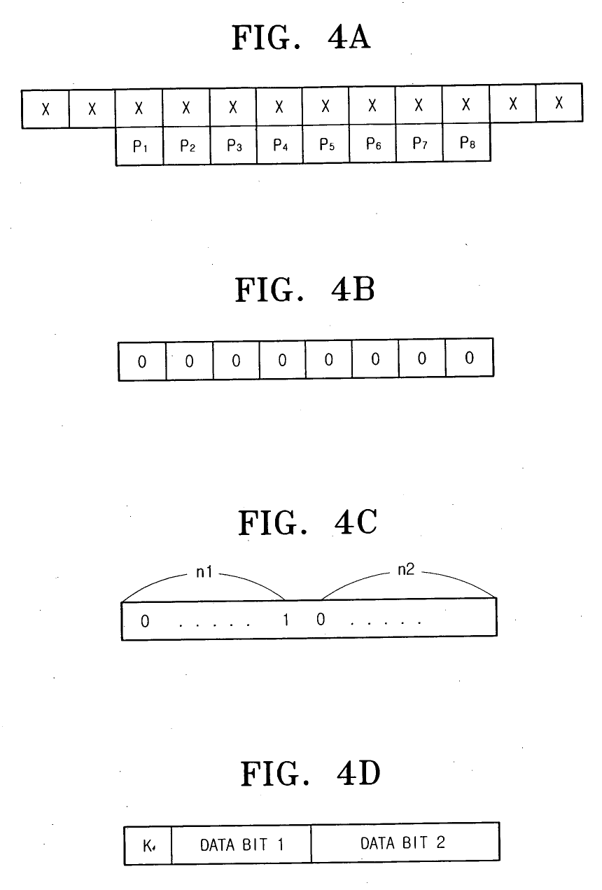

FIG. 3 is a flowchart illustrating a method of rapidly compressing a binary image using the exemplary system of FIG. 2 according to an embodiment of the present general inventive concept. FIGS. 4A to 4E illustrate pixels and patterns generated according to the method of FIG. 3.

Referring to FIGS. 3 and 4A to 4E, image data are input (S301) and, when the image data are initially input, the 0 count value and the 0 output control value are initialized (S303). Here, as noted hereinbefore, the 0 count value is obtained by counting the 0 blocks in which an error between the actual binary value of each block and the estimated binary value is 0. The 0 count value is obtained on a block-by-block basis, where a “block” may be considered a predetermined unit (having a predetermined size) of processing an image. The 0 output control value is the number of continuous 0 blocks. Thus, the 0 output control value determines the number of continuous 0 blocks when information on the kind of error that indicates the 0 blocks is coded. Initially, the 0 count value is set as binary “0” and the 0 output control value is set as “1”. In the discussion below, a block is considered to be composed of 8 bits, as an example.

Then, it is determined whether the input of the image data is completed (S305). This determination at operation S305 is carried out by determining whether a signal that informs that the input of the image data is completed is input (e.g., to the host apparatus 100).

When the input of the image data is not completed, the pixel values of the current block of the input image to be coded are estimated (S307). The pixel values of the current block of the input image are not estimated using the previous pixel values of the pixels to be coded in the current line, but are estimated using the binary values of the pixels of the previous line that is continuously input prior to the current line.

As illustrated in FIG. 4A, “Xs” denotes pixels of the previous line of the input image, and P1 to P8 denote pixels of one block of the current line to be coded. The pixel values of the pixels P1 to P8 of the current block to be coded are estimated using the binary values of Xs that are the pixels of the previous line.

In the present embodiment, the average value of the values obtained by multiplying the binary values of the predetermined pixels of the previous line by the corresponding screen mask values of the predetermined pixels of the previous line is calculated to be estimated as the pixel values of the current line.

Then, the binary value of the current block is estimated using the estimated pixel values of the current block and the screen mask values corresponding to the current block (S309). In the present embodiment, the estimated pixel values, i.e., those pixel values that are the average value of the values obtained by multiplying the binary values of the previous line by the screen mask values corresponding to the previous line are compared with the corresponding screen mask values of the current line. When it is determined that the estimated pixel value of a pixel is larger than its corresponding screen mask value, the binary value of that pixel is determined as 1. When the estimated pixel value is smaller than the screen mask value, the binary value of the pixel is determined as 0.

FIG. 4B illustrates the case in which all estimated binary values of one block of the current line are 0. Referring to FIG. 4B, a comparison of the estimated pixel values of one block of 8 bits with the screen mask values corresponding to that block, results in the determination that the estimated pixel values are smaller than the screen mask values. This determination corresponds to the 0 block in which all pixel values are 0 as shown in FIG. 4B.

Referring back to FIG. 3, the estimated binary values are then compared with the actual binary values to calculate the error values of the current block (S310). When the estimated binary values of the current block are equal to the corresponding actual binary values, the error values are determined as binary “0.” When the estimated binary values are different from the corresponding actual binary values, the error values are determined as binary “1” to generate the error patterns of the current block.

In the present embodiment, it is determined whether the calculated error values are 0 (S311). In other words, it is determined whether the current block is the 0 block in which no errors exist between the estimated binary values and the corresponding actual binary values.

When it is determined that the calculated error values are 0, the 0 count value is increased (S313). In other words, when it is determined that the calculated error values of the current block are 0, the 0 count value obtained by counting the number of blocks whose binary values are 0 is increased.

Thereafter, it is determined whether the 0 output control value is equal to the 0 count value (S315). It is noted here that the 0 output control value provides information on the number of 0 blocks among the continuous previous blocks appearing prior to the current block. On the other hand, the 0 count value is obtained, as noted before, by counting the number of 0 blocks including the current block.

When the 0 output control value is equal to the 0 count value, the following operations are performed: the outputs of the blocks corresponding to the 0 count value (which is obtained by counting the number of 0 blocks including the current block) are determined as 0; the 0 count value is initialized; and the 0 output control value is increased (S317). When it is determined that the current block is the 0 block whose error values are 0 and that the 0 count value is equal to the 0 output control value, the kind of error is coded to data in which error values are 0 for the number of blocks corresponding to the 0 output control value. The 0 count value is initialized to 0 so that the 0 count value is counted again for the next block after the coded current block. Also, when the blocks related to the 0 output control value are the 0 blocks, the 0 output control value is increased by one so that the associated kind of error is coded to data in which the error values are 0.

When it is determined in the operation S311 that all of the calculated error values of the current block are not 0, that is, at least one error value is 1 among the calculated error values, a determination of whether one error value is 1 among the calculated error values is performed (S319).

When one error value is 1 among the calculated error values, it is determined whether the calculated error values are equal to the error values calculated in the previous block that was coded prior to the current block (S321). FIG. 4C illustrates the case in which one error value is 1 among the error values calculated in a block being coded. In FIG. 4C, a reference “n1” denotes the number of bits having the value 0 before a “1” appears among the error values-, whereas a reference “N2” denotes the number of bits having the value 0 after a “1” appears among the error values.

When the error values calculated in the previous block are equal to the error values calculated in the current block to be coded, the kind of error corresponding to the above and having a value of “110” is output to code the current block (S322). Here, the value “110” represents the coding with respect to that kind of error where the error values calculated in the block to be coded are equal to the error values calculated in the previous block. In the present embodiment, the value “110” is predetermined for its associated kind of error.

FIG. 4D illustrates the structure of an error pattern. FIG. 4E illustrates a table representing the kinds of error and contents related to the kinds of error. In FIGS. 4D and 4E, “K” denotes the kind of error, that is, information on whether the calculated error values are 0 or 1. The data bit 1 and the data bit 2 in FIG. 4D (“Data 1” and “Data 2” in FIG. 4E, respectively) are additional information items in accordance with the kind of error. The information on the data bit 1 and data bit 2 vary with the kind of error.

Referring to FIG. 4E, when the error values between the actual binary values of the current block to be coded and its estimated binary values are 0, the kind of error is 0. That is, when the error values are 0, a “0” value is output when the current block is coded. When one error value is 1 among the error values (different from the result of the error values of the previous block), the kind of error is 10. When one error value is 1 among the error values (the same as the result of the previous block), the kind of error is 110. In another error image pattern, the kind of error of 111 is output (in which the calculated error values are output as they are). When the error image pattern is 0, as illustrated in operations S311 to S317, the 0 count value (representing the number of 0 blocks in which the error values are 0) is increased.

Referring again to FIG. 3, when it is determined in operations S319 and S321 that one error value is 1 among the error values of the current block and that the error values calculated in the previous block are different from the error values of the current block, the kind of error 10 corresponding to this situation is output to code the current block (S323). This is also illustrated in FIG. 4E, where it is shown that when the error values calculated in the previous block are different from the error values of the current block, the corresponding kind of error 10 is output.

Then, as shown in FIG. 3, in addition to the kinds of error, two additional items are also output at S325: (1) information on “n1” that denotes the number of bits having the value of 0 and appearing before a “1” appears in the current bock, and (2) the 0 count value corresponding to the number of continuous 0 blocks after the coded block. Also, “n2” (FIG. 4C) that denotes the number of bits having the value of 0 and appearing after a “1” appears may be output instead of n1 (that denotes the number of bits having the value of 0 and appearing before a “1” appears). Since the total number of bits in a block is previously set, the information on the number of bits having the value of 0 and appearing before a “1” appears and the information on the number of bits having the value of 0 and appearing after “1” appears is coded to decompress the block.

On the other hand, when it is determined in operation S319 that two or more error values are 1 among the error values of the current block, the corresponding kind of error “111” is output to code the current block (S329). As also illustrated in FIG. 4E, when two or more error values are 1 among the error values, the corresponding kind of error is “111.”

When the kind of error 111 is output, the error values of the current block are output as they are (S331).

After coding the blocks and the contents in accordance with the kinds of error (in the format shown, for example, in FIG. 4D) in operations S322, S323, and S329, the 0 count value is initialized and the 0 output control value is reduced (S327). When all of the error values of the current block are not 0, then, 110, 10, and 111 are output in accordance with the respective cases as described above. Then, the 0 count value obtained by counting the number of 0 blocks is initialized to count the number of 0 blocks again. Also, when the current block does not correspond to the 0 block, the 0 output control value (which is information on the number of continuous 0 blocks) is reduced by one.

When the next block continuous to the current block is input after coding the current block (in operation S317 or S327 in accordance with whether the error values of the current block are 0), the operations from the operation S307 in FIG. 3 are repeated. On the other hand, when the next block is not input, coding is terminated.

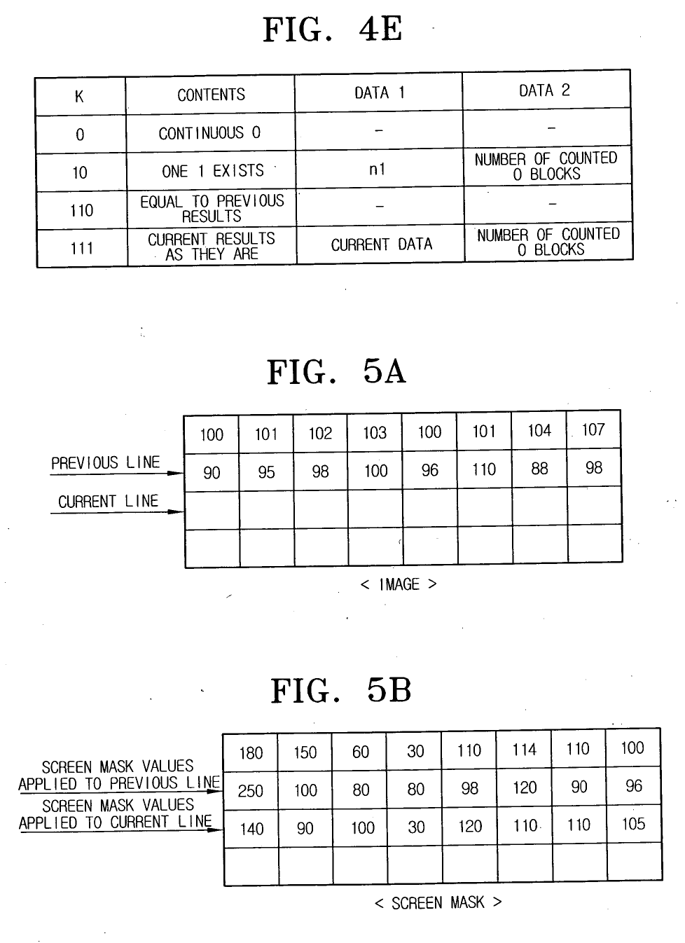

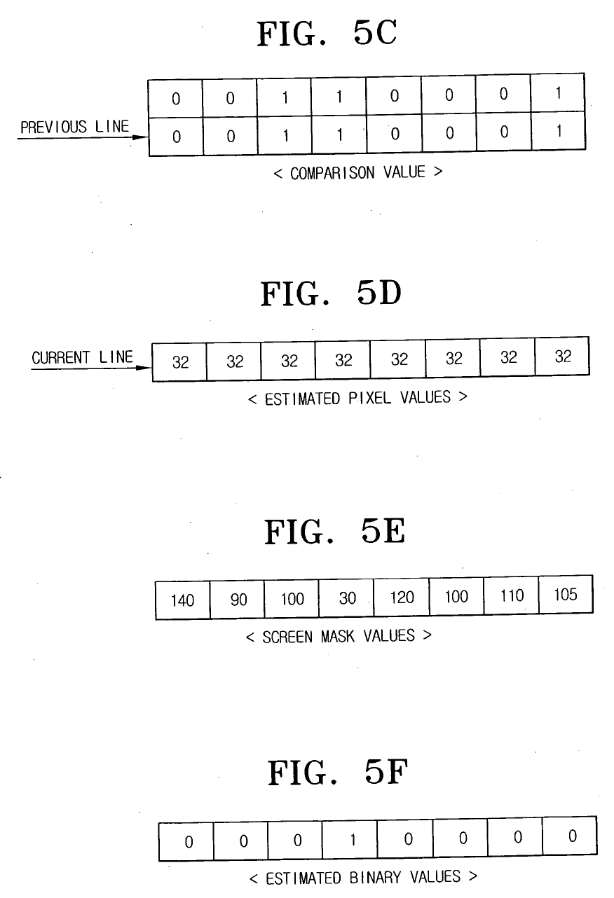

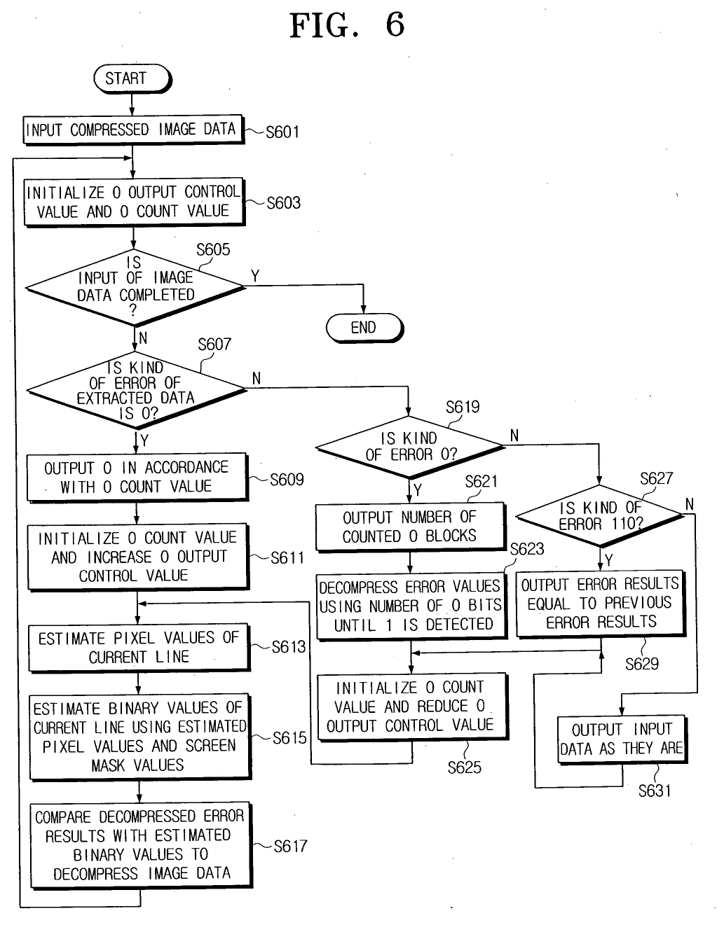

FIGS. 5A to 5F illustrate values generated according to the method of FIG. 3. FIG. 5A illustrates the input image in which the pixel values of the respective pixels are displayed by line. FIG. 5B illustrates screen mask values to be applied to the pixel values in the input image of FIG. 5A. FIG. 5C illustrates the resultant values obtained by applying the screen mask values of FIG. 5B to the pixel values of the input image of FIG. 5A. It is noted here that each line in FIGS. 5A-5F constitutes only one block. Hence, line size equals block size in the embodiments of FIGS. 5A-5F.

Referring to FIG. 5C, the binary values of the previous line (indicated by an arrow on the left of FIG. 5C) used during the estimating of the pixel values of the current block are estimated using the pixel values of the previous line of FIG. 5A and the screen mask values applied to the previous line of FIG. 5B. That is, (90, 95, 98, 100, 96, 110, 88, 98) that are the pixel values of the previous line are compared with (250, 100, 80, 80, 98, 120, 90, 96) that are the screen mask values applied to the previous line so that the binary values of the previous line are determined as 1 when the pixel values of the previous line are larger than the screen mask values and are determined as 0 when the pixel values of the previous line are smaller than the screen mask values. Therefore, the binary values of the previous line used during the estimating of the pixel values of the current block are (0, 0, 1, 1, 0, 0, 0, 1) as illustrated in FIG. 5C.

FIG. 5D illustrates the pixel values of the current block that are estimated using the results of FIG. 5C and the corresponding screen mask values of FIG. 5B for the previous line.

Referring to FIG. 5D, the pixel values of the current block are determined as the average of the values obtained by multiplying the binary values of the previous line by the screen mask values of the previous line. More specifically, the values obtained by multiplying (0, 0, 1, 1, 0, 0, 0, 1) that are the binary values of the previous line by (250, 100, 80, 80, 98, 120, 90, 96) that are the screen mask values of the previous line are 80, 80, and 96. Then, the addition of the values of 80, 80, and 96 is 256, and the average value of the addition of the values of 80, 80, and 96 is 32 obtained by dividing 256 by 8 which is the total number of pixels in a block or in a block size. Thus, the pixel values of the current block are estimated as 32.

FIG. 5E illustrates the screen mask values to be applied to the current block to be coded. These screen mask values are also illustrated in the third row (from the top) in FIG. 5B. FIG. 5F illustrates the binary values of the current block that are estimated using the estimated pixel values of the current block of FIG. 5D and the screen mask values of FIG. 5E applied to the current block.

Referring to FIGS. 5E and 5F, the binary values of the current line or block are estimated using the estimated pixel values of the current line of FIG. 5D and the screen mask values of the current line of FIG. 5E. The estimated pixel values of the current block are compared with the screen mask values of the current block corresponding to the estimated pixel values. As a result of comparison, the binary values of the current block are determined as 1 when it is determined that the estimated pixel values are larger than the corresponding screen mask values and are determined as 0 when it is determined that the estimated pixel values are smaller than the corresponding screen mask values. Therefore, the estimated binary values of the current block are (0, 0, 0, 1, 0, 0, 0, 0) as illustrated in FIG. 5F.

The actual binary values of the current block are compared with the estimated binary values, as shown in FIG. 5F, so that the error values of the current block of the current line are determined as 0 when it is determined that the actual binary values are equal to the estimated binary values and are determined as 1 when it is determined that the actual binary values are different from the estimated binary values. Therefore, when the estimated binary values of the current block are (0, 0, 0, 1, 0, 0, 0, 0), as shown in FIG. 5F, and the actual binary values of the current block are (0, 0, 1, 1, 0, 0, 0, 0), the error values are (0, 0, 1, 0, 0, 0, 0, 0).

FIG. 6 is a flowchart illustrating a method of rapidly decompressing a binary image according to an embodiment of the present general inventive concept. The method of rapidly decompressing the binary image is similar to performing the above-described compressing method of FIG. 3 in the reverse order.

Referring to FIGS. 3 and 6, the image data compressed using the binary values of the previous line that is continuously input prior to the current line of an image are received (S601).

Then, the 0 output control value and the 0 count value are initialized (S603). Here, the 0 count value is obtained by counting the 0 blocks in which the data of a block, that is, a predetermined unit of processing an image, are 0. The 0 output control value controls is an output value that corresponds to the kind of error in which error values are 0 during the coding and denotes the number of continuous 0 blocks. In the present embodiment, the 0 count value is initially set as a binary 0 and the 0 output control value is initially set as a binary 1.

Then, it is determined whether the input of the compressed image data is completed (S605). The determination of whether the input of the image data is completed is performed by determining whether a signal that informs that the input of the image data is completed is input.

Then, it is determined whether the kind of error of the data extracted from an input image corresponds to the kind of error in which the error values of one block are a binary 0 (S607). That is, it is determined whether the kind of error of the block of the image to be decompressed is the data in which no errors exist between the actual binary values and the estimated binary values during compression.

When the extracted data correspond to the kind of error in which the error values are 0, 0 is output in accordance with the 0 count value to decompress the error values (S609). Since the 0 count value denotes the number of continuous 0 blocks in which no errors exist between the actual binary values and the estimated binary values. Therefore, when the kind of error corresponds to the output of 0 in which the error values are 0, the bits having the value of 0 are output according to the number of bits per block (i.e., eight bits, each having a value of a binary 0, may be output in a case of a block of 8 bit-size) and according to the number of 0 blocks corresponding to the 0 count value to decompress the error values. For example, in a case of three 0 blocks (i.e., 0 count value=3), a total of twenty four (8×3=24) bits may be output during decompression.

Then, the 0 count value is initialized and the 0 output control value is increased (S611). Since 0 is output according to the number of 0 blocks, the 0 count value is set as 0 to initialize the 0 count value. Since the current block is the 0 block so that the error values of the current block are initialized to 0, 0 is output as the error values of the blocks next to the current block, and also the 0 output control value corresponding to the number of continuous 0 blocks is increased.

Thereafter, the pixel values of the current block to be decompressed are estimated (S613). The pixel values of the current block are estimated using the binary values of the previous line continuously input prior to the current line (which includes the current block) and the screen mask values corresponding to the binary values of the previous line. Referring to FIGS. 5B and 5C, the average value of the values obtained by multiplying the binary values of the previous line by the screen mask values corresponding to the previous line is estimated as the pixel values of the current block.

Then, the binary values of the current block to be decompressed are estimated using the estimated pixel values and the corresponding screen mask values of the current block (S615). The estimated pixel values of the current block are compared with corresponding ones of the screen mask values so that the binary values of the current block are determined as 1 when the estimated pixel values are larger than corresponding ones of the screen mask values and are determined as 0 when the estimated pixel values are smaller than corresponding ones of the screen mask values.

The error values decompressed in operation S609 are compared with the binary values of the current block estimated in operation 615 to decompress the image data (S617). Since the error values decompressed in operation S609 correspond to the kind of error 0 illustrated as a binary value of “0” in FIG. 4E, no errors exist between the actual binary values of the block to be coded and the estimated binary values of the current line. Therefore, to compress the image data, the binary values estimated by the number of 0 blocks corresponding to the 0 count value are determined as the binary values of the blocks of the current line to decompress the image data.

On the other hand, when the kind of error of the data to be decompressed in the step S607 is not 0, it is determined whether the kind of error is 10 (S619). That is, it is determined whether one error value is 1 among the error values of the current block to be coded and whether the error values of the current block are not equal to the error values of the previous block.

When the kind of error is 10, the error values are decompressed using the number of “0” bits having the value of 0 to the point at which the continuously input error value is 1 (S623). Because when the kind of error is 10, one error value is 1 among the error values of the current block to be decompressed and the error values of the current block are not equal to the error values of the previous block. Therefore, the error values of one block are decompressed using a number of bits each having the value of 0 to the point at which the error value is 1. The error values are determined as 0 according to the number obtained by subtracting the number of bits to the point at which the error value is 1, from the total number of bits of one block, that is, the number of bits present in the block after the point at which the error value is 1.

When information exists on the number of 0 blocks counted in the continuous previous block immediately prior to the input current block, in addition to the information on the number of bits having the value of 0 to the point at which the error value is 1, the error values of the block immediately previous to the current block are decompressed using the information. That is, when the number of counted 0 blocks is 2, the information conveys that the kind of error is “0” in the two previous blocks continuously input prior to the current block, the kind of error is 0. However, the kind of error is not output as 0 since the 0 count value is not equal to the 0 output control value. Therefore, before decompressing the error values of the current block, the kind of error 0 is decompressed by the number of blocks corresponding to the number of counted 0 blocks (S621).

Thereafter, the 0 count value is initialized and the 0 output control value is reduced (S625). Since the error values of the previous block are decompressed by the number of 0 blocks counted in the continuous previous blocks prior to the current block, the 0 count value is set as 0 to initialize the 0 count value. Since the kind of error of the current block is not 0, the 0 blocks in which one block has bits having the value of 0 are not continuously input, and the 0 output control value that is information on the number of continuous 0 blocks is reduced by one.

The pixel values of the current line to be decompressed are estimated in the operation S613 and the binary values of the current line to be decompressed are estimated in the operation S615. The error values decompressed in the operation S623 are compared with the estimated binary values in the operation S617 so that the estimated binary values are determined as the actual binary values of the current block when the error values are 0 and that the inverted values of the estimated binary values are determined as the actual binary values when the error values are 1 to decompress the compressed image data.

On the other hand, when it is determined that the kind of error is not “10” in the operation S619, it is determined whether the kind of error is “110” (S627). That is, it is determined whether one error value is “1” among the error values of the current block and whether the error values of the current block are equal to the error values of the previous block continuously input prior to the current block.

When the kind of error is 110, the same error results as the error values of the previous block are output (S629). Then, the same processes as the processes after operation S625 are performed to decompress the compressed image data.

When it is determined that the kind of error is not 110 in operation S627, the binary values of the current block are output as the error values of the current block (S631). When the kind of error is not 110, it may indicate that two or more error values are 1 among the error values of the current block, which may indicate that the kind of error is “111.” When the kind of error is 111, the error values of the current block that are input to be continuous with the information on the kind of error are used as they are. The error values of the previous block input immediately prior to the current block are decompressed using information on the number of counted 0 blocks input to be continuous with the data on the error values of the current block. As illustrated in operation S623, in the two previous blocks continuously input immediately prior to the current block, the kind of error is 0, however, the kind of error is not equal to the 0 output control value, so that the kind of error is not output as 0. Therefore, the kind of error 0 is decompressed by the number of blocks corresponding to the number of counted 0 blocks before decompressing the error values of the current block. Then, the same processes as the processes after the step S625 are performed to decompress the compressed image data.

As described above, according to the present embodiment, the input image is not compressed and decompressed pixel-by-pixel, but is compressed and decompressed by block-by-block where a block in a line of an image includes the pixels of a predetermined number. The compression and decompression are performed using the pixel values of the previous line continuously input prior to the current line and also using the screen mask values, so that it is possible to rapidly process the image data.

Therefore, a large amount of rapidly compressed image data can be transmitted to the image data decompressing apparatus within a predetermined time to output the image data.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of compressing a binary image, the method comprising:
initializing a 0 count value which is changed by counting the number of 0 blocks in which actual binary values of a current block are equal to estimated binary values thereof in an input image containing a plurality of lines each formed of one or more blocks each containing a plurality of predetermined number of pixels;
initializing a 0 output control value that represents information on the number of the 0 blocks appearing continuously in the input image;
estimating pixel values of the current block using binary values of a previous line that is continuously input prior to the current line to be coded and also using the screen mask values corresponding to the previous line;
estimating the binary values of the current block using the estimated pixel values and the screen mask values corresponding to the current block;
comparing the estimated binary values with the actual binary values of the current block to calculate errors, and generating an error pattern according to the errors; and
coding the current line block by block based on the 0 count value, the 0 output control value, and the generated error pattern.

2. The method as claimed in claim 1, further comprising:
determining whether the input of the input image is completed,
wherein, when the input of the input image is not completed, the 0 count value and the 0 output control value are initialized, and when the input of the input image is completed, the coding of the current line is terminated.

3. The method as claimed in claim 1, wherein the estimating of the pixel values of the current block comprises:
multiplying the binary values of the previous line by the screen mask values corresponding to the previous line to generate a set of intermediate values; and
averaging the set of intermediate values to obtain an average value representing the estimated pixel values of the current block.

4. The method as claimed in claim 1, wherein the estimating of the binary values of the current block comprises:
comparing the estimated pixel values of the current block with the screen mask values corresponding to the current block to estimate the binary values of the current block.

5. The method as claimed in claim 1, wherein the initializing of the 0 count value and the 0 output control value comprises:
setting the 0 count value as binary “0”; and setting the 0 output control value as binary “1”.

6. The method as claimed in claim 1, wherein the error pattern comprises at least one of the following:
a pattern in which the errors do not exist;
a pattern in which one error exists and which is the same as the error pattern of the previous block continuously input immediately prior to the current block;
a pattern in which one error exists and which is different from the error pattern of the previous block; and
a pattern in which two or more errors exist.

7. The method as claimed in claim 1, wherein the block by block coding of the current line comprises coding the current line according to at least one of the following:
data on the error pattern in accordance with the error pattern;
the 0 count value;
the number of bits before and after the bit in which one error exists in the error pattern; and
data on errors in the block being coded.

8. The method as claimed in claim 1, wherein the coding of the current line comprises coding the current line such that data on the errors are included in the coding of the current line when one error exists and the error pattern is the same as the error pattern of the previous block continuously input immediately prior to the current block and when no errors exist.

9. The method as claimed in claim 1, wherein the coding of the current line comprises coding the current line such that information on the number of bits before and after the bit having an error and information on the 0 count value are included in the coding of the current line when one error exists and when the error pattern is different from the error pattern of the previous block continuously input immediately prior to the current block, the 0 count value being the number of blocks in the input image in which no errors exist among the blocks appearing previous to the current block being coded.

10. The method as claimed in claim 1, wherein the coding of the current line comprises coding the current line such that information on data on the errors and information on the 0 count value are included in the coding of the current line when two or more errors exist in accordance with the error pattern, the 0 count value being the number of blocks in the input image in which no errors exist among the blocks appearing previous to the current block being coded.

11. The method as claimed in claim 1, wherein the coding of the current line comprises:
increasing the 0 count value when no errors exist in accordance with the error pattern; and
initializing the 0 count value and increasing the 0 output control value when the increased 0 count value is equal to the 0 output control value.

12. The method as claimed in claim 1, wherein the coding of the current line comprises:
reducing the 0 output control value and initializing the 0 count value when one error exists in accordance with the error pattern.

13. A method of decompressing a binary image, the method comprising:
decompressing an error pattern of a coded block in the input image containing a plurality of coded lines each formed of one or more coded blocks each being a processing unit and having a predetermined pixels, according to the error pattern between actual binary values generated by the coded block and estimated binary values for the block;
estimating the pixel values of the block using the binary values of a previous line continuously input prior to the current line to be decompressed and using the screen mask values corresponding to the previous line;
estimating the binary values of the block using the estimated pixel values and the screen mask values corresponding to the block; and
decompressing the image data of a coded current line based on the estimated binary values of the coded block in the coded current line and the decompressed error pattern.

14. The method as claimed in claim 13, further comprising:
determining whether the input of the input image is completed,
wherein, when the input of the input image is not completed, the 0 count value and the 0 output control value are initialized, and when the input of the input image is completed, the coding of the current line is terminated.

15. The method as claimed in claim 13, wherein the estimating of the pixel values of the block comprises:
multiplying the binary values of the previous line by the screen mask values corresponding to the previous line to generate a set of intermediate values; and
averaging the set of intermediate values to obtain an average value representing the estimated pixel values of the block.

16. The method as claimed in claim 13, wherein the estimating of the binary values of the block comprises:
comparing the estimated pixel values of the block with the screen mask values corresponding to the block to estimate the binary values of the block.

17. The method as claimed in claim 13, wherein the decompressed error pattern comprises at least one of the following:
a pattern in which the errors do not exist;
a pattern in which one error exists and which is the same as the error pattern of a previous block continuously input immediately prior to the current coded block;
a pattern in which one error exists and which is different from the error pattern of the previous block; and
a pattern in which two or more errors exist.

18. The method as claimed in claim 13, wherein the decompressing of the image data of the current line is performed on a block-by-block basis using at least one of the following:
data on the error pattern in accordance with the decompressed error pattern;
the 0 count value obtained by counting 0 blocks, where a block in a coded line to be decompressed in the input image is considered one of the 0 blocks when the actual binary values of the block are equal to estimated binary values thereof; and
the number of bits before and after the bit in which one error exists in the block being decompressed; and
data on errors in the block being decompressed.

19. The method as claimed in claim 13, wherein the decompressing of the image data of the current line comprises decompressing the image data using first information on the number of bits before and after the bit having an error and second information on the 0 count value, which indicates the number of blocks in which no errors exist among the previous blocks, when one error exists and the error pattern is different from the error pattern of the previous block continuously input immediately prior to the block being decompressed.

20. The method as claimed in claim 13, wherein the decompressing of the image data of the current line comprises:
decompressing the image data using first information on data on the errors and second information on the 0 count value, which indicates the number of blocks in which no errors exist among the previous blocks continuously input prior to the current block, when two or more errors exist between the actual binary values of the block being decompressed and the estimated binary values in accordance with the error pattern.

21. The method as claimed in claim 13, wherein the decompressing of the image data of the current line comprises:
initializing the 0 count value, which is obtained by counting 0 blocks in which a 0 block is in a coded line to be decompressed in the input image and is considered one of the 0 blocks when the actual binary values of the block are equal to estimated binary values thereof, and increasing the 0 output control value, which represents information on the number of 0 blocks appearing continuously in the input image, when no errors exist between the actual binary values of the block being decompressed and the estimated binary values thereof in accordance with the error pattern.

22. The method as claimed in claim 13, wherein the step of decompressing the image data of the current line comprises:
reducing the 0 output control value, which is obtained by counting 0 blocks, wherein a block in a coded line to be decompressed in the input image is considered a 0 block when the actual binary values of the block are equal to estimated binary values thereof, and initializing the 0 count value, which represents information on the number of 0 blocks appearing continuously in the input image, when one error exists between the actual binary values of the block being decompressed and the estimated binary values thereof in accordance with the error pattern.

23. An apparatus to compress a binary image, the apparatus comprising:
a host counter to update a 0 count value, which is obtained by counting the number of 0 blocks in which the actual binary values of the current block are equal to estimated binary values thereof in an image containing a plurality of lines each formed of one or more blocks each containing a plurality of predetermined number of pixels, and to update a 0 output control value, which represents information on the number of 0 blocks appearing continuously in the input image;
an estimator to estimate the pixel values of the current block using the binary values of a previous line that is continuously input prior to the current line to be coded, and to estimate the binary values of the current block using the estimated pixel values;
an error image generator to compare the estimated binary values with the actual binary values of the current block to calculate errors, and to generate an error pattern according to the calculated errors;
a coding unit to code the current line based on the 0 count value, the 0 output control value, and the generated error pattern; and
a controller to initialize the 0 output control value and the 0 count value in accordance with the generated error pattern and for determining whether the coding of the input image is terminated.

24. The apparatus as claimed in claim 23, further comprising:
a host storage unit to store the screen mask values of the input image, the actual binary values of the input image, the kinds of error patterns, and the contents of data in accordance with the kinds of error patterns.

25. The apparatus as claimed in claim 23, wherein the estimator calculates an average value of values obtained by multiplying the binary values of the previous line by the screen mask values corresponding to the previous line to estimate pixel values of the current block, and compares the estimated pixel values of the current block with the screen mask values corresponding to the current block to estimate the binary values of the current block.

26. The apparatus as claimed in claim 23, wherein the host counter increases the 0 count value when no errors exist in accordance with the error pattern, and initializes the 0 count value and increases the 0 output control value when the increased 0 count value is equal to the 0 output control value.

27. The apparatus as claimed in claim 23, wherein the host counter reduces the 0 output control value and initializes the 0 count value when one error exists in accordance with the error pattern.

28. The apparatus as claimed in claim 23, wherein the coding unit codes the current line such that first information on the number of bits before and after the bit having an error and second information on the 0 count value, which is the number of blocks in the input image in which no errors exist among the blocks appearing previous to the current block being coded, are included as part of the coding by the coding unit when one error exists and when the error pattern is different from the error pattern of the previous block continuously input immediately prior to the current block.

29. An apparatus to decompress a binary input image, the apparatus comprising:
an error image decompressing unit to decompress a coded block based on the an error pattern between the actual binary values generated by the coded block and estimated binary values for the block in an input image containing a plurality of coded lines with each line being formed of one or more coded blocks each representing a unit of processing the input image;
a counter to update a 0 count value, which is obtained by counting the number of 0 blocks, in which the actual binary values are equal to the estimated binary values, and a 0 output control value that is information on the number of continuous 0 clocks in the input image;
a calculating unit to calculate the pixel values of the block using the binary values of a previous line continuously input prior to the current line to be decompressed and to calculate the binary values of the block using the estimated pixel values;
a decoding unit to decompress the image data of a coded current line based on the estimated binary values of the coded block in the coded current line and the decompressed error pattern; and
a controller to initialize the 0 output control value and the 0 count value in accordance with the decompressed error pattern, and to determine whether the decompression of the input image is terminated.

30. The apparatus as claimed in claim 29, further comprising:
a storage unit to store the screen mask values of the input image, the actual binary values of the image, the kinds of error, and the contents of data in accordance with the kinds of error.

31. The apparatus as claimed in claim 29, wherein the calculating unit calculates an average value of values obtained by multiplying the binary values of the previous line by the screen mask values corresponding to the previous line to estimate pixel values of the block being decompressed, and compares the estimated pixel values of the block being decompressed with the screen mask values corresponding to the block to calculate the binary values of the block.

32. The apparatus as claimed in claim 29, wherein the counter initializes the 0 count value and increases the 0 output control value when no errors exist between the actual binary values of the block being decompressed and the estimated binary values thereof, and initializes the 0 count value and reduces the 0 output control value when at least one error exists in accordance with the error pattern.

33. The apparatus as claimed in claim 29, wherein the decoding unit performs decompression of the image data of the current line on a block-by-block basis using at least one of data on the error pattern in accordance with the decompressed error pattern; the 0 count value, the number of bits before and after the bit in which one error exists in the block being decompressed, and data on errors in the block being decompressed.

34. The apparatus as claimed in claim 29, wherein the decoding unit performs decompression using first information on the number of bits before and after the bit having an error and second information on the 0 count value that is the number of blocks in which no errors exist among the previous blocks when one error exists and the error pattern is different from the error pattern of the previous block continuously input immediately prior to the coded block being decompressed.

35. The apparatus as claimed in claim 29, wherein the unit performs decompression using information on data on the errors and information on the 0 count value that is the number of blocks in which no errors exist among the previous blocks continuously input prior to the block when two or more errors exist between the actual binary values of the block being decompressed and the estimated binary values in accordance with the error pattern.

36. A system to rapidly compress and decompress a binary input image, the system comprising:
a host counter to update a 0 count value that is obtained by counting the number of 0 blocks in which the actual binary values of the current block are equal to the estimated binary values thereof in a binary image containing a plurality of lines with each line being formed of one or more blocks, wherein each block contains a plurality of predetermined number of pixels, and to update a 0 output control value representing information on the number of 0 blocks appearing continuously in the input image;
an estimator to estimate the pixel values of the current block using the binary values of a previous line that is continuously input prior to the current line to be coded or decompressed, and to estimate the binary values of the current block using the estimated pixel values;
an error image generator to compare the estimated binary values with the actual binary values of the current block to calculate errors, and to thus generate an error pattern;
a coding unit to code the current line based on the 0 count value, the 0 output control value, and the generated error pattern;
an error image decompressing unit for decompressing the error pattern of a coded current block in a coded current line based on the error pattern between the actual binary values generated by the coded block and estimated binary values for the block;
a decoding unit to decompress the image data of the coded current line based on the estimated binary values of the coded block in and the decompressed error pattern; and
a controller to initialize the 0 output control value and the 0 count value in accordance with the generated error pattern, and to determine whether the coding and decompression of the input image are terminated.

37. A method of rapidly compressing and decompressing an input binary image, the method comprising:
initializing a 0 count value which is changed by counting the number of 0 blocks in which actual binary values of the current block are equal to estimated binary values thereof in an input image containing a plurality of lines with each line being formed of one or more blocks, wherein each block contains a plurality of predetermined number of pixels, and a 0 output control value representing information on the number of 0 blocks appearing continuously in the input image;
estimating the pixel values of the current block using the binary values of a previous line continuously input prior to the current line to be coded or decompressed, and also using the screen mask values corresponding to the previous line;
estimating the binary values of the current block using the estimated pixel values and the screen mask values corresponding to the current block;
comparing the estimated binary values with the actual binary values of the current block to calculate errors and to thus generate an error pattern;
coding the current line block by block based on the 0 count value, the 0 output control value, and the generated error pattern;
decompressing a coded block in the input image based on the error pattern between the actual binary values generated by the coded block and estimated binary values for the coded block; and
decompressing the image data of a coded current line based on the estimated binary values of the coded block in the coded current line and the decompressed error pattern.

38. An apparatus to compress a binary image, the apparatus comprising:
a host counter to receive an input image containing at least a previous line and a current line having at least previous and current blocks, respectively, each having a plurality of predetermined number of pixels such that the input image is processed block-by-block basis, and to generate a 0 count value, which is obtained by counting the number of 0 blocks in which actual binary values of the current block are equal to respective estimated binary values thereof, and a 0 output control value, which represents information on the number of 0 blocks appearing continuously in the input image;
an estimator to estimate pixel values of the current block using binary values of the previous block, and to estimate the binary values of the current block using the estimated pixel values of the current block;
an error image generator to compare the estimated binary values with the actual binary values of the current block to calculate one or more errors, and to generate an error pattern according to the calculated one or more errors; and
a coding unit to code the current block based on the 0 count value, the 0 output control value, and the generated error pattern.

39. An apparatus to decompress a binary input image, the apparatus comprising:
a controller to receive an input image containing at least previous and current lines having at least previous and current coded blocks, respectively, each representing a unit of processing the input image;
an error image decompressing unit to determine an error pattern using actual binary values of the coded block and estimated binary values of the coded block to decompress the coded current block;
a counter to generate a 0 count value, which is obtained by counting the number of 0 blocks, in which the actual binary values are equal to corresponding ones of the estimated binary values, and a 0 output control value that is information on the number of continuous 0 clocks in the input image;
a calculating unit to calculate pixel values of the coded current block using the binary values of the previous block of the previous line continuously input prior to the current line to be decompressed, and to calculate binary values of the current block using the estimated pixel values; and
a decoding unit to decompress image data of the coded current block of the current line according to the estimated binary values of the coded block in the coded current line and the decompressed error pattern.

40. A system to rapidly compress and decompress a binary input image, the system comprising:
a host apparatus comprising:
a host counter to receive an input image containing at least a previous line and a current line having at least previous and current blocks, respectively, each having a plurality of predetermined number of pixels such that the input image is processed block-by-block basis, and to generate a 0 count value, which is obtained by counting the number of 0 blocks in which actual binary values of the current block are equal to respective estimated binary values thereof, and a 0 output control value, which represents information on the number of 0 blocks appearing continuously in the input image,
an estimator to estimate pixel values of the current block using binary values of the previous block, and to estimate the binary values of the current block using the estimated pixel values of the current block,
an error image generator to compare the estimated binary values with the actual binary values of the current block to calculate one or more errors, and to generate an error pattern according to the calculated one or more errors, and
a coding unit to code the current block based on the 0 count value, the 0 output control value, and the generated error pattern; and
an image forming apparatus:
a controller to receive an input image containing at least previous and current lines having at least previous and current coded blocks, respectively, each representing a unit of processing the input image,
an error image decompressing unit to determine an error pattern using actual binary values of the coded block and estimated binary values of the coded block to decompress the coded current block,
a counter to generate a 0 count value, which is obtained by counting the number of 0 blocks, in which the actual binary values are equal to corresponding ones of the estimated binary values, and a 0 output control value that is information on the number of continuous 0 clocks in the input image,
a calculating unit to calculate pixel values of the coded current block using the binary values of the previous block of the previous line continuously input prior to the current line to be decompressed, and to calculate binary values of the current block using the estimated pixel values, and
a decoding unit to decompress image data of the coded current block of the current line according to the estimated binary values of the coded block in the coded current line and the decompressed error pattern.

41. An apparatus to compress a binary image, the apparatus comprising:
a host counter to receive an input image containing at least a previous line and a current line having at least previous and current blocks, respectively, each having a plurality of predetermined number of pixels such that the input image is processed block-by-block basis;
an estimator to estimate pixel values of the current block using binary values of the previous block, and to estimate the binary values of the current block using the estimated pixel values of the current block;
an error image generator to compare the estimated binary values with the actual binary values of the current block to calculate one or more errors, and to generate an error pattern according to the calculated one or more errors; and
a coding unit to code the current block of the input image in a unit of block based on the generated error pattern.

42. An apparatus to decompress a binary input image, the apparatus comprising:
a controller to receive an input image containing at least previous and current lines having at least previous and current coded blocks, respectively, each representing a unit of processing the input image;
an error image decompressing unit to determine an error pattern using actual binary values of the coded block and estimated binary values of the coded block to decompress the coded current block;
a calculating unit to calculate pixel values of the coded current block using the binary values of the previous block of the previous line continuously input prior to the current line to be decompressed, and to calculate binary values of the current block using the estimated pixel values; and
a decoding unit to decompress image data of the coded current block of the current line in a unit of a block according to the estimated binary values of the coded block in the coded current line and the decompressed error pattern.

43. A system to rapidly compress and decompress a binary input image, the system comprising:
a host apparatus comprising:
a host counter to receive an input image containing at least a previous line and a current line having at least previous and current blocks, respectively, each having a plurality of predetermined number of pixels such that the input image is processed block-by-block basis,
an estimator to estimate pixel values of the current block using binary values of the previous block, and to estimate the binary values of the current block using the estimated pixel values of the current block,
an error image generator to compare the estimated binary values with the actual binary values of the current block to calculate one or more errors, and to generate an error pattern according to the calculated one or more errors, and
a coding unit to code the current block based on the 0 count value, the 0 output control value, and the generated error pattern; and
an image forming apparatus:
a controller to receive an input image containing at least previous and current lines having at least previous and current coded blocks, respectively, each representing a unit of processing the input image,
an error image decompressing unit to determine an error pattern using actual binary values of the coded block and estimated binary values of the coded block to decompress the coded current block,
a calculating unit to calculate pixel values of the coded current block using the binary values of the previous block of the previous line continuously input prior to the current line to be decompressed, and to calculate binary values of the current block using the estimated pixel values, and
a decoding unit to decompress image data of the coded current block of the current line according to the estimated binary values of the coded block in the coded current line and the decompressed error pattern.

44. A method of compressing an input image containing a plurality of lines with each line being formed of one or more blocks, wherein each block contains a plurality of predetermined number of pixels, the method comprising:
obtaining binary values for a previous line from the screen mask values corresponding to the previous line and also from the actual pixel values for the previous line, wherein the previous line is continuously input prior to a current line to be coded;
estimating the pixel values of a current block in the current line to be coded using the binary values of the previous line and also using the screen mask values corresponding to the previous line;
estimating the binary values of the current block using the estimated pixel values of the current block and also using the screen mask values corresponding to the current block;
comparing the estimated binary values of the current block with the actual binary values thereof to calculate errors and to thus generate an error pattern; and
coding the current line block by block using the generated error pattern.
